(19) United States
(12) Patent Application Publication
(10) Pub. No.: US 2015/0360359 A1
(43) Pub. Date: Dec. 17, 2015

(54) FASTENER GUN CAPABLE OF PREVENTING ACCIDENTAL DISCHARGING

(71) Applicant: Basso Industry Corp., Taichung (TW)

(72) Inventors: An-Gi LIU, Taichung (TW); Fu-Yi HUANG, Taichung (TW)

(21) Appl. No.: 14/305,002

(22) Filed: Jun. 16, 2014

(51) Int. Cl. B25B 31/00; B23P 19/00; B25C 1/00

(52) U.S. Cl. CPC B25B 31/00; B25C 1/008; B23P 19/001

(57) ABSTRACT

A fastener gun capable of preventing accidental discharging includes a gun body, a safety unit and a fastener magazine. The gun body has a firing channel and the safety unit is disposed adjacent the firing channel. The fastener magazine is utilized to guide a fastener strip. The fastener gun further includes a connecting portion and a stopping bar. The stopping bar is disposing on the connecting portion and capable of moving between a first position and a second position. The stopping bar has a pushing portion and a stop portion. The pushing portion may be optionally pushed by the fastener strip. When the stopping bar locates at the first position, the stop portion stops the movement of the safety unit. When the stopping bar locates at the second position, the stop portion does not stop the movement of the safety unit.

### BACKGROUND

1. Field of Invention

The present invention relates to an electric/pneumatic tool (fastener gun) for continuous use of fasteners. More particularly, the present invention relates to a fastener gun capable of preventing accidental discharging.

2. Description of Related Art

A conventional fastener gun was disclosed in Taiwan Application Serial Number 98101444 (Taiwan Publication Number 201026450 A1), titled “Method for continuous use of fasteners” (hereafter referred to as “444”). The application discloses that a fastener gun 10 fires fasteners 31 of the fastener strip 30 sequentially. When the fasteners 31 are fired respectively, the feed member 13 may push the fastener strip 30 so that the next fastener 31 enters the firing channel.

However, as shown in FIG. 6 of “444”, the feed member 13 pushes the second fastener 31 of the fastener strip 30 so that the first fastener 31 enters the firing channel. When the fastener gun fires the fasteners repeatedly till the fastener strip 30 remains only one fastener 31, the movement of the feed member 13 can not push the last fastener 31 into the firing channel thoroughly so that the last fastener 31 locates under the firing channel. At this moment, if the firing action is executed, the fastener gun may be damaged. For the forgoing reasons, there is a need for providing a safety mechanism to prevent the fastener gun from firing when the residual fastener of the fastener strip is insufficient.

Moreover, the user usually makes the muzzle of the fastener gun 10 knock the work-piece in order to ensure if the fastener gun can fire or not. Therefore, the structure of the safety mechanism should preferably meet the habit of the users. Accordingly, it is convenient for usage, and it also prevents the safety mechanism from damage owing to wrong operation.

### SUMMARY

One aspect of the present disclosure is providing a fastener gun capable of preventing accidental discharging when the residual fastener of the fastener strip is insufficient.

Another aspect of the present disclosure is providing a fastener gun capable of preventing accidental discharging, and providing a safety unit meeting the habit of the users. The safety unit has long life cycle.

In order to achieve the aspects above and others, the present disclosure provides a fastener gun capable of preventing accidental discharging. The fastener gun capable of preventing accidental discharging includes a gun body, a safety unit and a fastener magazine. The gun body has a firing channel to receive a fastener. The safety unit is disposed adjacent the firing channel and may move between a non-firing position and a firing standby position. The fastener magazine is connected to the firing channel and is utilized to guide a fastener strip consisting of a plurality of fasteners. The fastener gun capable of preventing accidental discharging further includes a connecting portion disposing between the fastener magazine and the firing channel. The fastener gun capable of preventing accidental discharging further includes a stopping bar disposing on the connecting portion and capable of moving between a first position and a second position. The stopping bar has a pushing portion and a stop portion. The pushing portion may be optionally pushed by the fastener strip in the fastener magazine. The stop portion may optionally stop a movement of the safety unit. When the stopping bar locates at the first position, the fastener strip dose not push the pushing portion and the stop portion stops the movement of the safety unit. When the fastener strip pushes the pushing portion so that the stopping bar locates at the second position, the stop portion does not stop the movement of the safety unit.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of the fastener gun according to one preferable embodiment of the present disclosure;

FIG. 2 is a partial perspective view of the fastener gun with the safety unit at non-firing position and the stopping bar at the second position according to one preferable embodiment of the present disclosure;

FIG. 3 is a partial exploded view of the fastener gun according to one preferable embodiment of the present disclosure;

FIG. 4 is a partial side view of the fastener gun with the safety unit at firing standby position and the lever at the stop position according to one preferable embodiment of the present disclosure;

FIG. 5 is a partial cross-section view of the fastener gun with the stopping bar at the second position according to one preferable embodiment of the present disclosure;

FIG. 6 is a partial side view of the fastener gun with the lever at the release position according to one preferable embodiment of the present disclosure;

FIG. 7 is a partial side view of the fastener gun with the fastener strip remaining only one fastener according to one preferable embodiment of the present disclosure;

FIG. 8 a partial cross-section view of the fastener gun with the stopping bar at the first position according to one preferable embodiment of the present disclosure; and

FIG. 9 is a partial perspective view of the fastener gun with the safety unit at non-firing position and the stopping bar at the first position according to one preferable embodiment of the present disclosure.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

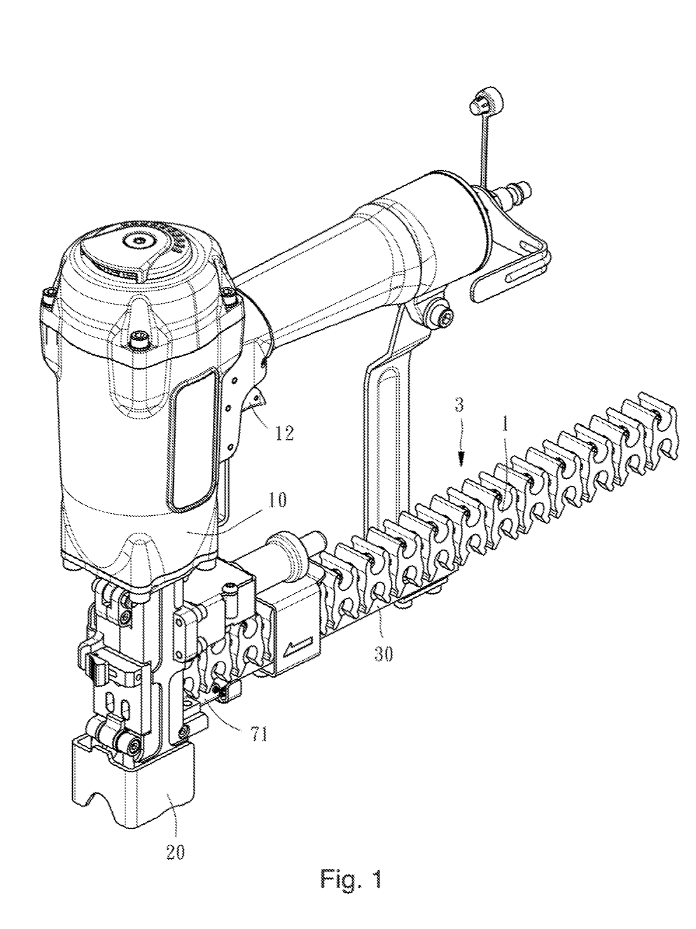

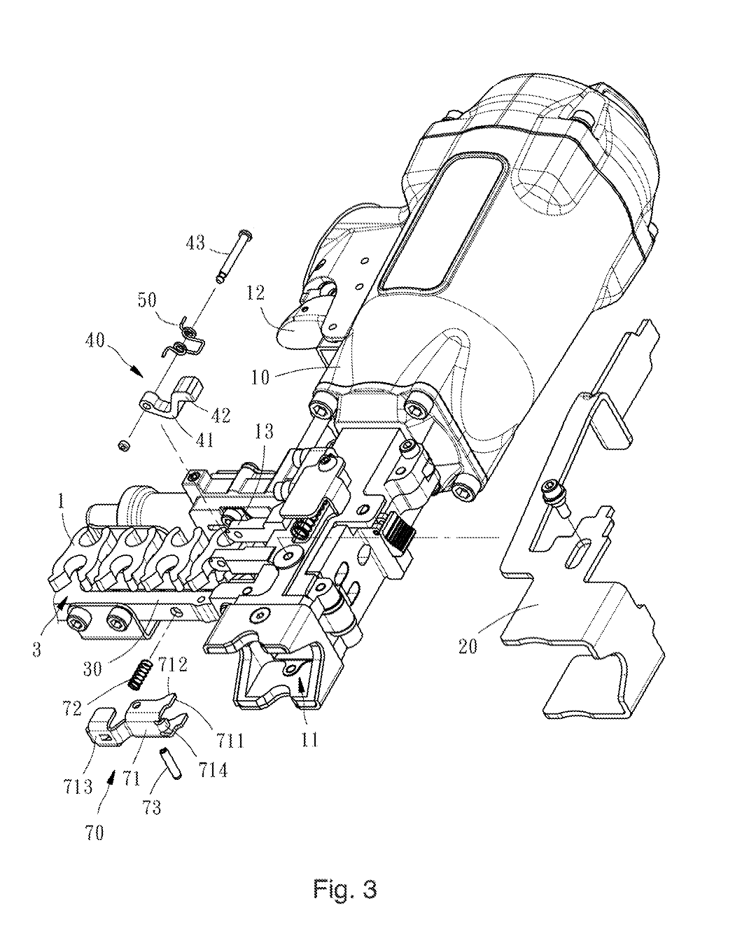

Referring to FIGS. 1 to 3, according to one preferable embodiment of the present disclosure, the fastener gun capable of preventing accidental discharging includes a gun body 10, a safety unit 20, a fastener magazine 30, a stopping bar 40, a first elastic member 50, a feed member 60 and a preventing separation mechanism 70.

The gun body 10 has a firing channel 11 to receive a fastener 1, and a trigger 12. When the firing conditions are satisfied, the user pulls the trigger 12 and actuates the rammer (not shown) so that the fastener 1 in the firing channel 11 is fired. The fastener gun capable of preventing accidental discharging has a connecting portion 13 disposing between the fastener magazine 30 and the firing channel 11. In this embodiment, the connecting portion 13 is disposed on a side of the gun body 10 adjacent to the fastener magazine 30.

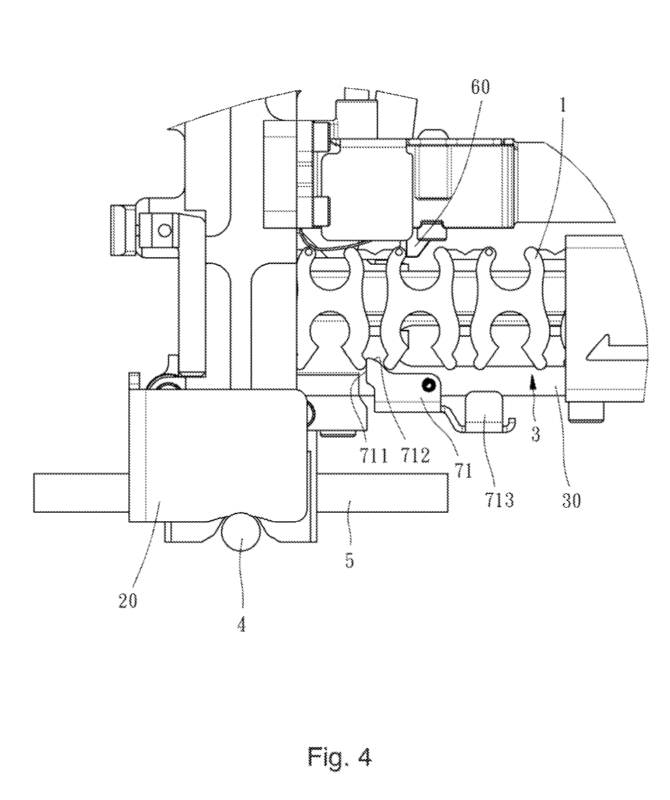

One of the firing conditions above is controlled by the safety unit 20. The safety unit 20 is disposed in the firing channel 11 and may move between a non-firing position and a firing standby position. When the safety unit 20 locates at the non-firing position (as shown in FIGS. 1, 2, 7, 9), the trigger 12 cannot be pulled. In other word, even the trigger 12 is pulled, the rammer may not be driven in order to secure that the fastener 1 in the firing channel 11 not to be fired. When the safety unit 20 locates at the firing standby position (as shown in FIG. 4) and the other firing conditions are satisfied (for example, the pneumatic fastener gun is connected to the high-pressure air source, or the electric fastener gun is connected to the power source), the user may pull the trigger 12 and actuate the rammer so that the fastener 1 is fired. The detailed structure and relationship of the trigger 12, the safety unit 20 and the rammer are not repeated herein because they are not the protection scope of the present disclosure but are similar to the prior art.

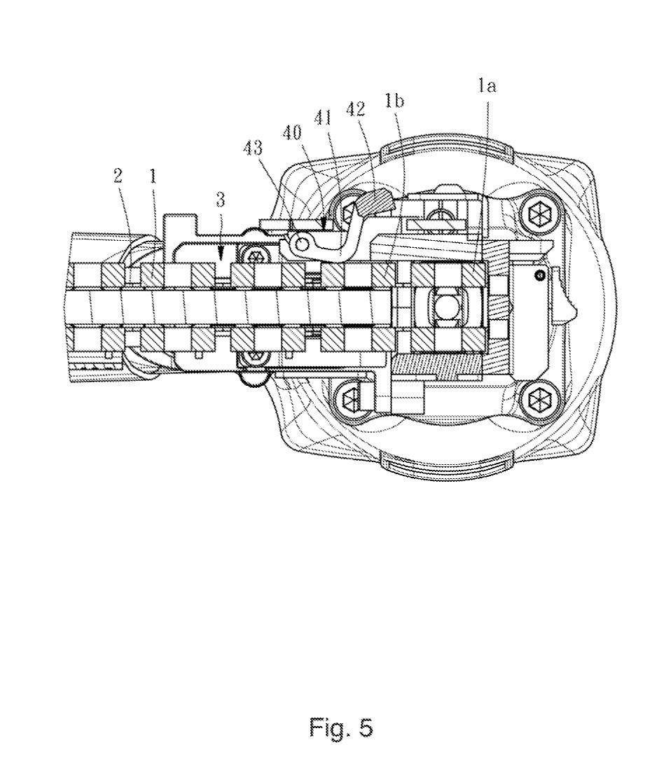

The fastener magazine 30 is connected to the firing channel 11 and is utilized to guide the fastener strip 3 consisting of a plurality of fasteners 1. For explanation, the fastener 1 of the fastener strip 3 locating in the firing channel 11 is referred as a first fastener 1a, and the fastener 1 adjacent to the first fastener 1a is referred as a second fastener 1b. The fastener strip 3 further includes several connection sections 2 connecting every two adjacent fasteners (for example, the first fastener 1a and the second fastener 1b, or every two adjacent fasteners 1, as shown in FIG. 5). In this embodiment, each of the fasteners 1 has an upper opening and a lower opening. The fasteners 1, 1a, 1b are utilized to fasten the two shafts 4, 5 vertically intersected with each other. The shafts 4, 5 can be reinforcing steel bars, referring to FIG. 4. The other structures of the fastener strip 3 and the fasteners 1, 1a, 1b are not the subject matters of the present disclosure and are conventional arts. For example, a possible embodiment of a fastener strip and a fastener is disclosed in the Taiwan application serial number 98101444. Therefore, the structures are not repeated herein.

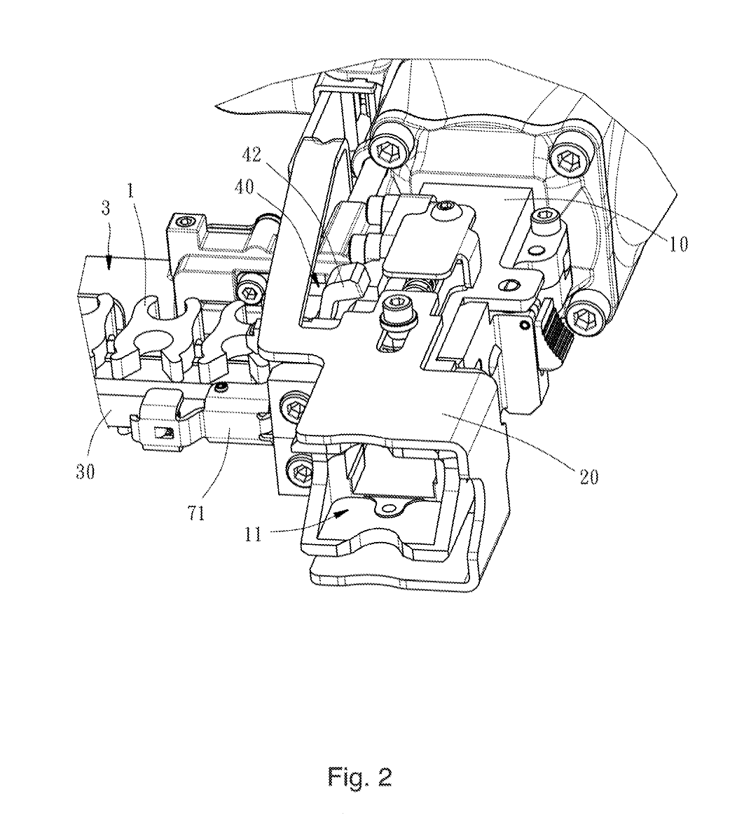

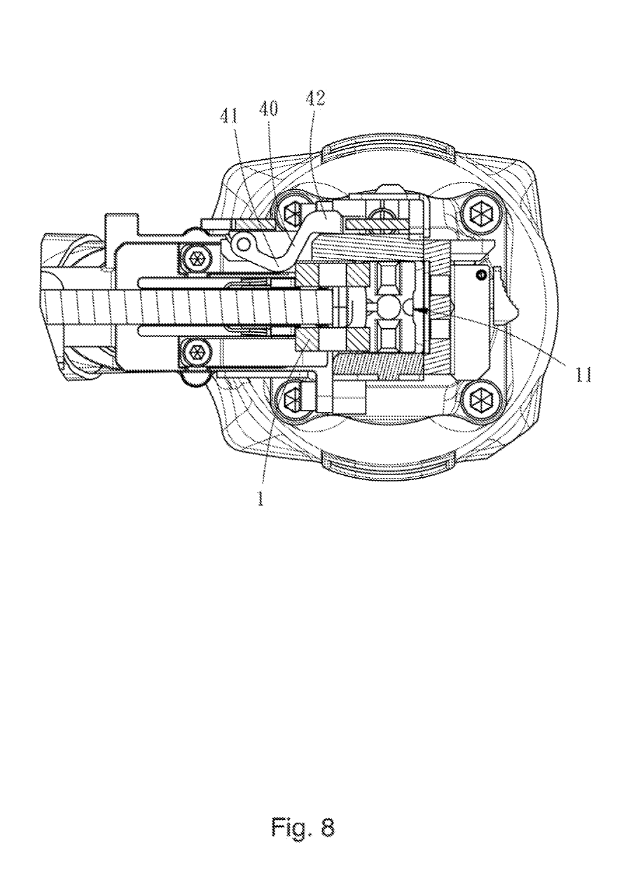

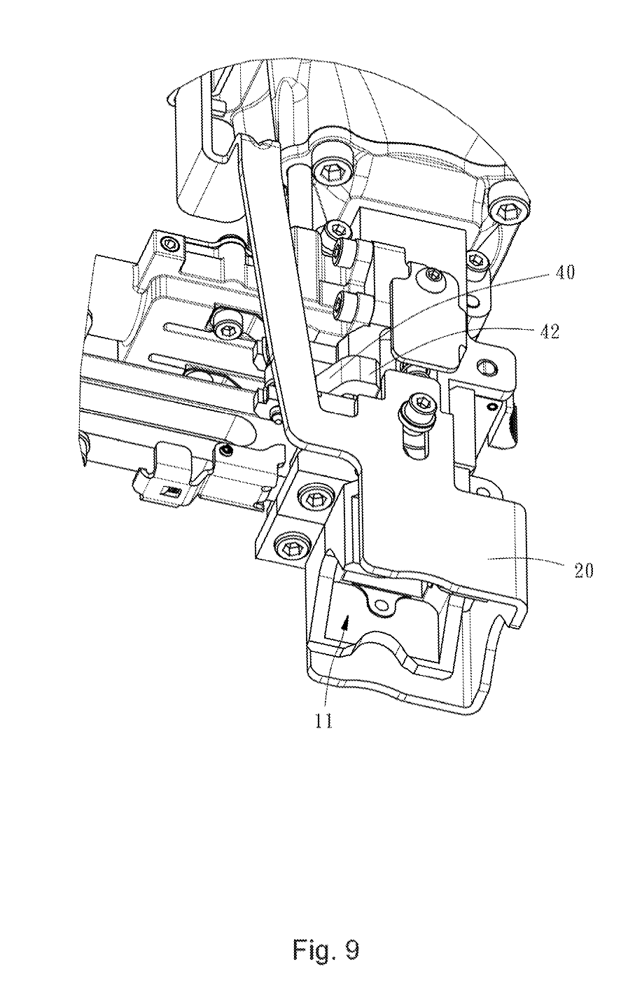

By a pivot 43, the stopping bar 40 is disposed on the connecting portion 13 of the gun body 10 so that the stopping bar 40 may swing or move between a first position (as shown in FIGS. 8, 9) and a second position (as shown in FIGS. 2, 5). The stopping bar 40 has a pushing portion 41 and a stop portion 42. The pushing portion 41 may be optionally pushed by the fastener strip 3 in the fastener magazine 30. The stop portion 42 may stop the movement of the safety unit 20.

The first elastic member 50 is utilized to provide the stopping bar 40 with an elastic force in order to move back the stopping bar 40 to the first position. In this embodiment, the first elastic member 50 is a torsion spring disposed between the stopping bar 40 and the connecting portion 13. However, the first elastic member 50 may be replaced by other spring, rubber and the like in different type.

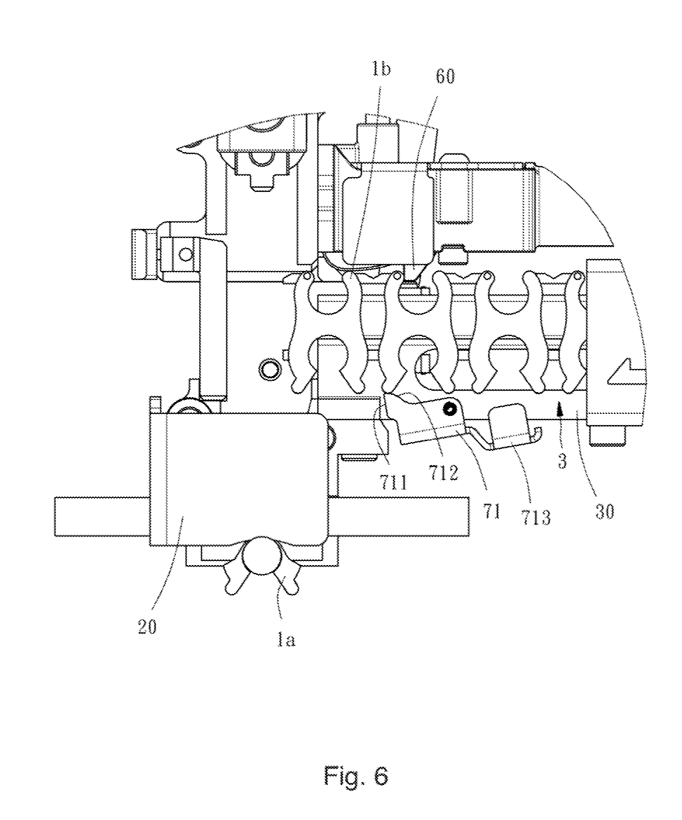

The feed member 60 is utilized to push one fastener of the fastener strip 3 at a predetermined position. For instance, the upper opening of the fastener 1 is pushed so that the fastener strip 3 is moved in the first direction toward the firing channel 11. For example, after the first fastener 1a is fired, the feed member 60 pushes the fastener strip 3 so that the second fastener 1b enters the firing channel 11 (as shown in FIG. 6). The feed member 60 may be interlocked with the trigger 12 or the rammer. The feed member 60 may be pneumatic and controlled by the trigger 12. The detailed structure of the feed member 60 is not the subject matter of the present disclosure and is the conventional art. Thus, it is not repeated herein.

The preventing separation mechanism 70 includes a lever 71 and a second elastic member 72. By a pivot 73, the lever 71 is pivoted on the fastener magazine 30 so that the lever 70 may swing between a stop position (as shown in FIG. 4) and a release position (as shown in FIG. 6). The lever 71 has a stop surface 711, a tapered pushing surface 712 and a pushing arm 713. A distance between the tapered pushing surface 712 and the firing channel 11 is larger than that between the stop surface 711 and the firing channel 11. When the lever 71 is located at the stop position, the stop surface 711 is vertical to the first direction. Besides, the lever 71 further includes a withstand portion 714. When the lever 71 is located at the stop position, the withstand portion 714 pushes the fastener magazine 30 so that the lever 71 cannot swing close to the fastener magazine 30. The second elastic member 72 is utilized to provide the lever 71 with an elastic force in order to move back the lever 71 to the stop position. In this embodiment, the second elastic member 72 may be a coil spring and disposed between the pushing arm 713 and the fastener magazine 30. However, the type and the configuration of the second elastic member 72 are not limit to those disclosed in this embodiment.

The operation of the fastener gun according to this embodiment is explained below through the accompanying drawings.

As shown in FIGS. 2, 4, when the feed member 60 pushes the fastener strip 3 in the first direction until the first fastener 1a enters the firing channel 11, the lever 71 locates at the stop position. Then, the stop surface 711 pushes the fastener strip 3 so that prevents the fastener strip 3 from moving in the second direction far from the firing channel.

As shown in FIGS. 4, 5, the pushing portion 41 of the stopping bar 40 is pushed by the second fastener 1b of the fastener strip 3 so that the stopping bar 40 locates at the second position. Accordingly, the stop portion 42 of the stopping bar 40 may not stop the movement of the safety unit 20. The safety unit 20 can be moved from the non-firing position to the firing position when a user locating the firing channel 11 on the shafts 4, 5. The fastener gun may fire the first fastener 1a whenever the trigger 12 is pulled.

As shown in FIG. 6, after the user pulls the trigger 12 and the rammer fires the fastener 1a, the feed member 60 pushes the fastener strip 3 in the first direction. Simultaneously, the fastener strip 3 pushes the tapered pushing surface 712 so that the lever 71 swings to the release position and may not stop the feeding movement of the fastener strip 3. After the feeding operation of the fastener strip 3 is completed, the status of the fastener gun is recovered as shown in FIG. 2.

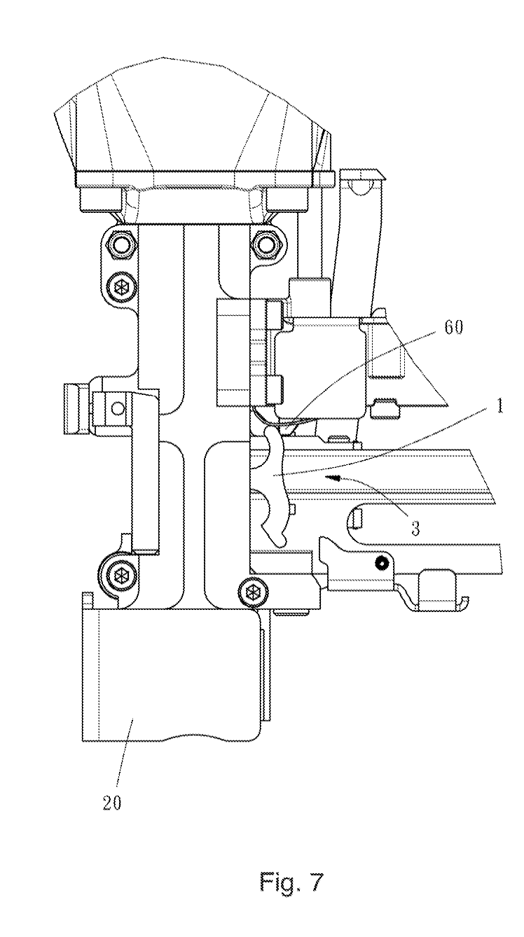

As shown in FIGS. 7 to 9, when the fastener gun fires the fasteners repeatedly till the fastener strip 3 remains only one fastener 1, the movement of the feed member 60 can not push the fastener 1 into the firing channel 11 thoroughly. At this moment, if the rammer hits the fastener 1, the fastener 1 may not be fired successfully so as to damage the fastener gun. Therefore, in the embodiment, the stopping bar 40 may get back to the first position, that is, the pushing portion 41 may not be pushed by the fastener strip 3. Then, the stop portion 42 may stop the movement of the safety unit 20 so that the safety unit 20 is kept at the non-firing position. Accordingly, the hitting action of the rammer is avoided. In other words, before the fastener strip is replaced by a new one, the fastener gun may not fire anymore.

According to the present disclosure, when the residual fastener of the fastener strip is insufficient (remaining only one fastener in the embodiment above), the accidental discharging can be avoided. However, the quantity of remaining fasteners may be changed by adjusting the disposing position of the stopping bar. Besides, the preventing separation mechanism may prevent the fastener gun from damaged by improperly pulling the fastener strip. Thus, the cost on maintenance of the fastener gun can be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of the present disclosure provided they fall within the scope of the following claims and their equivalents.

What is claimed is:

1. A fastener gun capable of preventing accidental discharging, comprising:
a gun body having a firing channel to receive a fastener;
a safety unit disposed adjacent the firing channel and moving between a non-firing position and a firing standby position;
a fastener magazine connected to the firing channel and being utilized to guide a fastener trip comprising a plurality of fasteners, wherein each of the fasteners has an opening adapted to be pushed by a feed member toward the firing channel so that the fastener strip is pushed;
a connecting portion disposed between the fastener magazine and the firing channel; and
a stopping bar disposed on the connecting portion and capable of pivotally moving between a first position and a second position, wherein the stopping bar has a pushing portion and a stop portion, the pushing portion is optionally pushed by the fastener strip in the fastener magazine, and the stop portion optionally stops a movement of the safety unit,
wherein when the stopping bar locates at the first position, the fastener strip dose not withstand the pushing portion and the stop portion stops the movement of the safety unit; and
wherein when the fastener strip pushes the pushing portion so that the stopping bar locates at the second position, the stop portion does not stop the movement of the safety unit.

2. The fastener gun capable of preventing accidental discharging of claim 1, further comprising:
an elastic member for providing an elastic force to the stopping bar to move the stopping bar back to the first position.

3. The fastener gun capable of preventing accidental discharging of claim 1, wherein the fastener strip further comprises a plurality of connection sections connecting every two adjacent fasteners.

4. The fastener gun capable of preventing accidental discharging of claim 3, wherein the fastener of the fastener strip locating in the firing channel is a first fastener and the fastener adjacent to the first fastener is a second fastener, and the second fastener pushes the pushing portion to locate at the second position.

5. The fastener gun capable of preventing accidental discharging of claim 2, wherein the fastener strip further comprises a plurality of connection sections connecting every two adjacent fasteners.

6. The fastener gun capable of preventing accidental discharging of claim 5, wherein the fastener of the fastener strip locating in the firing channel is a first fastener and the fastener adjacent to the first fastener is a second fastener, and the second fastener pushes the pushing portion to locate at the second position.

7. The fastener gun capable of preventing accidental discharging of claim 1, wherein the connecting portion is disposed on the gun body.

8. The fastener gun capable of preventing accidental discharging of claim 1, wherein the fastener has an upper opening and a lower opening.

9. The fastener gun capable of preventing accidental discharging of claim 1, wherein the stopping bar is disposed on the connecting portion of the gun body by a pivot, and the stopping bar moves or swings between the first position and the second position.
